(19) United States
(12) Patent Application Publication
(10) Pub. No.: US 2013/0139073 A1
(43) Pub. Date: May 30, 2013

(54) SYSTEM AND METHOD FOR CHANGING FUNCTIONALITIES OF WEBSITES USING WIDGETS

(71) Applicant: Revionics Inc., Roseville, CA (US)

(72) Inventors: Michelle Crames, Los Angeles, CA (US); James Berry, Denver, CO (US); Marc Jameson, Los Angeles, CA (US); Mikkel Garcia, Denver, CO (US); Gabe Hamilton, Arvada, CO (US); Clayton Meador, Denver, CO (US); Drake Emiko, Denver, CO (US); David Starr, Denver, CO (US)

(73) Assignee: Revionics Inc., Roseville, CA (US)

(21) Appl. No.: 13/673,979

(22) Filed: Nov. 9, 2012

Related U.S. Application Data
(60) Provisional application No. 61/557,497, filed on Nov. 9, 2011.
(60) Provisional application No. 61/693,223, filed on Aug. 24, 2012.

(51) Int. Cl. G06F 3/048

(52) U.S. Cl. CPC G06F 3/048
USPC 715/760

(57) ABSTRACT

A system and method for changing functionalities to websites uses a widget that retrieves at least one executable program file and a configuration file, which are published to a network, to execute the executable program and self-configure using the new configuration file.

### CROSS REFERENCE TO RELATED APPLICATION

This application is entitled to the benefit of U.S. Provisional Patent Application Ser. No. 61/557,497, filed on Nov. 9, 2011, and U.S. Provisional Patent Application Ser. No. 61/693,223, filed on Aug. 24, 2012, which are both incorporated herein by reference.

### BACKGROUND

In order to better promote businesses, operators of business websites may want to change the functionalities of their websites by adding new functionalities or modify existing functionalities. As an example, operators of business websites may want to introduce some social media functionalities to their websites to take advantage of the rise in social media usage.

Social media has changed how users interact with contents found on the Internet. These contents can include news, photos, videos, scientific articles and advertisements. Social media is widely used to promote businesses, such as retailers, by asking visitors to their websites to follow or to show support for their businesses on one or more social networking websites, such as Facebook or Twitter.

However, modifying existing business websites to include social media functionalities may involve a significant overhaul of their existing websites, and may also increase the complexity of operating the modified websites.

Thus, there is a need for a system and method that allows functionalities of business websites to be easily changed, such as adding new social media functionalities, without significantly increasing the complexity of operating the modified websites.

### SUMMARY

A system and method for changing functionalities of websites uses a widget that retrieves at least one executable program file and a configuration file, which are published to a network, to execute the executable program and self-configure using the new configuration file.

A method for changing functionalities of websites in accordance with an embodiment of the invention comprises providing a user interface for an operator of the website to configure the widget integrated into the website, publishing the executable program file to the network to allow the widget of the website access to the executable program file, and publishing a new configuration file to a network in response to configuration input made using the user interface to allow the widget of the website access to the new configuration file, wherein the widget of the website is configured to retrieve the executable program and the new configuration file to execute the executable program and self-configure using the new configuration file. In some embodiments, the steps of this method are performed when program instructions contained in a computer-readable storage medium is executed by one or more processors of a computer system.

A system in accordance with an embodiment of the invention comprises a widget to be integrated into a website, the widget including a reference to at least one executable program file and a mechanism to look for a configuration file for the widget, and a marketing support provider that has access to a network and websites, including the website with the widget, the marketing support provider including one or more servers that are configured to provide a user interface for an operator of the website to configure the widget integrated into the website, to publish the executable program file to the network to allow the widget of the website access to the executable program file, and to publish a new configuration file to a network in response to configuration input made using the user interface to allow the widget of the website access to the new configuration file, wherein the widget of the website is configured to retrieve the executable program and the new configuration file to execute the executable program and self-configure using the new configuration file.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a marketing system in accordance with an embodiment of the invention.

FIG. 2 illustrates the overall operation of the marketing system for using widgets integrated into business websites in accordance with an embodiment of the invention.

FIGS. 3-5 illustrate a process of integrating a social rewards “social gate” rewrite button onto a business website using widgets according to an embodiment of the invention.

FIG. 6 is a flow diagram of a method for providing functionalities to websites in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

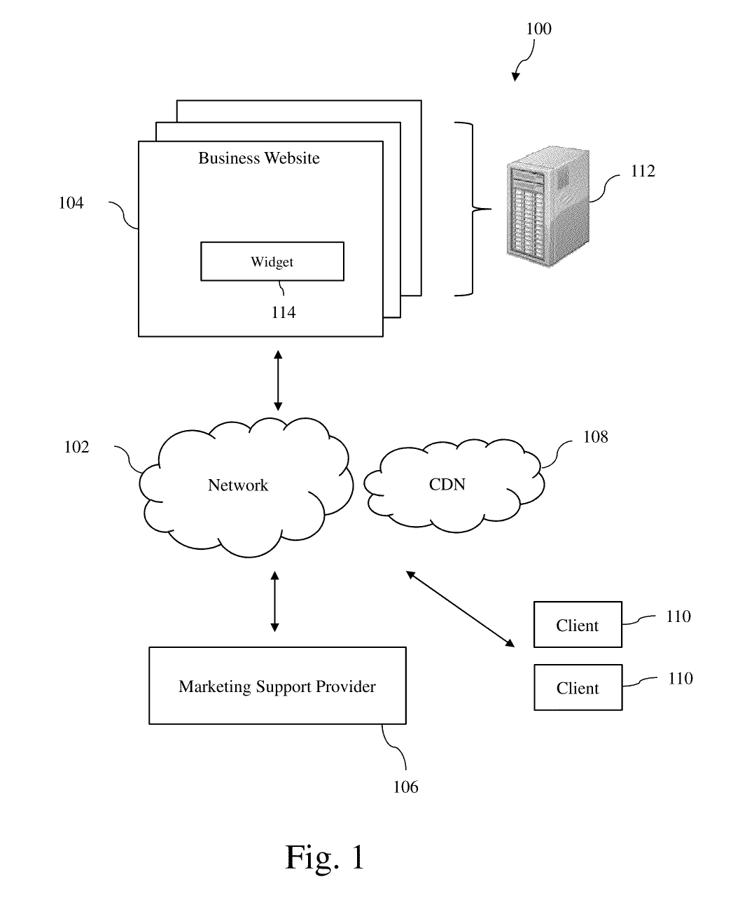

Turning now to FIG. 1, a marketing system 100 in accordance with an embodiment of the invention is shown. As shown in FIG. 1, the marketing system includes a network 102, business websites 104, a marketing support provider 106, a content delivery network (CDN) 108 and client computing devices 110. As described below, the marketing system allows business entities, such as retailers or service providers, the ability to deploy the latest technologies and techniques in social, mobile, ecommerce and in-store promotions directly to their websites with minimal integration.

The network 102 can be any type of computer network or a combination of networks that allows communications between devices connected to the network. The network 102 may include the Internet, a wide area network (WAN), a local area network (LAN), a storage area network (SAN), a fibre channel network and/or other networks.

The business websites 104 can be any type of business websites that can be accessed by the client computing devices 110 via the network 102. As an example, the business websites can be shopping websites to which customers can access and make online purchases of products or services offered by the business. These business websites can include any number of webpages, including webpages for checkout. Each of these business websites may be stored in one or more servers 112, which may be physical or virtual web servers.

The business websites 104 include one or more widgets 114, which have been integrated into at least some of the business websites, such as product webpages. These widgets contain codes to deploy various functionalities. Typically, these widgets allow customers who visit the business websites to take some form of action, which will produce results accordingly. These widgets do not rely on external services to configure the operating state of the widgets. Instead, the widgets rely on static configuration files. In particular, the widgets configure themselves based on the static configuration files that are deployed via the CDN 108. Operators of the business websites can setup configurations through an application program interface, which may be a user interface dashboard, and then “publish” these configuration files to the CDN. The widgets constantly look for new configuration files. When a new configuration file is found, the widget self-alters its functionality to match the configurations specified in the configuration file. Rendering, configuration and functionality are all executed on the client side, and do not have any initial dependencies on any external system, or webservice calls to any external system. This mechanism allows for extremely fast code rendering as well as a fault-tolerant deployment that is not dependent upon external services for initial functionality. Further details of the widgets and their functionalities and operations will be described below.

The marketing support provider 106 operates to support the business websites 104. In particular, the marketing support provider supports the widgets 114 integrated into the business websites. The marketing support provider provides application program interface (API) to allows the operators of the business websites to configure the widgets integrated into the business websites. The marketing support provider also publishes the configuration files via the CDN 108 when the configurations of the widgets have been changed by the operators of the business websites using the API.

In some embodiments, the marketing support provider 106 receives and processes client actions with respect to the widgets, such as when a button on a webpage provided by a widget has been pressed. This client action information is collected so that analytics can be provided to the operators of the business websites 104.

In addition, the marketing support provider 106 may provide webpages, screens or windows that can complement the business websites. As an example, the marketing support provider may provide shopping cart screens, which may be new windows or websites, in response to customer interactions with the widgets on the webpages.

The marketing support provider 106 may perform various operations, including the operations described above, using any combination of software, firmware and hardware. In an embodiment, the marketing support provider uses software programs running on one or more servers to perform the various operations. These servers may be physical or virtual servers.

The CDN 108 is a network that provides web service for content delivery, such as Amazon CloudFront or service provided by Akamai. The CDN operates to push content to distributed nodes around the internet, so that when a client computing device accesses a resource (like a JavaScript file), it gets the closest node and then can download the resource as quickly as possible. Since CDNs are well known in the art, the CDN is not further described herein.

The client computing devices can be any type of network-enabled devices. As an example, the client computing devices may be desktop computers, notebook computers and/or Internet-enabled mobile devices. The client computing devices include web browsers or other web browsing applications, which can be used to access the business websites via the network.

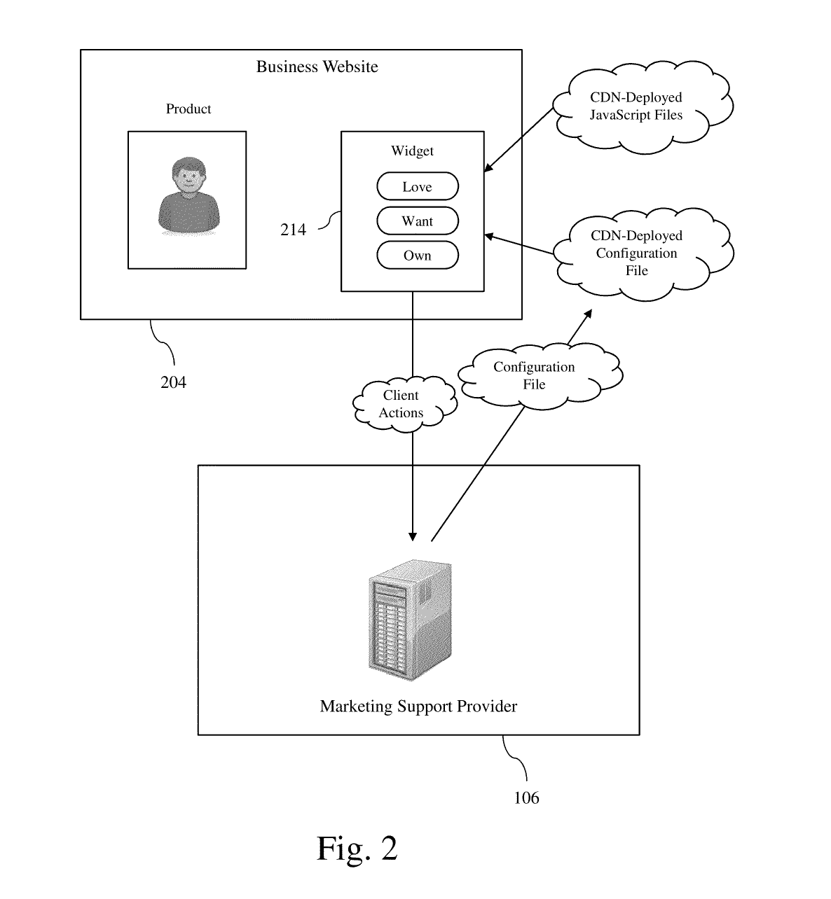

The overall operation of the marketing system 100 for using widgets integrated into business websites is described with reference to FIG. 2. As shown in FIG. 2, a business website 204 includes a widget in accordance with embodiments of the invention. The widget is added to the business website, for example, a product webpage, by the operator of the business website. In an embodiment, this process consists of adding two JavaScript include statements in the header of a webpage as well as a container area (e.g., div or iframe) where the desired functionality will be rendered. The default state of the widget is to be in the “off” state. In the “off” state, nothing new is rendered to the webpage and the user sees the webpage as it existed before the “blank” widget was added to the page. The widget may be deployed with a secure business or merchant identification (ID). The widget, when rendered on a client computing device, retrieves and executes the JavaScript files, for example, CDN-deployed JavaScript files, and then constantly looks for a published configuration file that defines the widget, for example, a CDN-deployed configuration file. If no configuration file is found, the widget remains in the “off” state. If several versions of a configuration file exist, the widget always uses the latest configuration file to define its functionality.

In an embodiment, the JavaScript files that are linked to the widget 214 have all the code embedded within them to find the configuration file. It will look at a specific location, or hit a webservice to find the latest reference to the configuration file. The JavaScript has the capability to look at a directory of configuration files and use their file names to determine which is the most recent.

After the widget 214 is added to the business website 204, the operator of the business website can configure the widget by logging into the API or dashboard to create a new widget configuration, alter an existing widget configuration, or turn off the widget. The operator of the business website can use a graphical interface of the API to determine how the widget should behave with respect to its functionality and/or features. Once the operator of the business website has configured the widget, the configuration can be published. When a publish event occurs, the marketing support provider creates a formatted configuration file and distributes it to the CDN 108 with a directory structure, name and security tokens that indicate the widget to be modified. In an embodiment, the configuration file includes the business ID, the widget identification, the webpage and the time when the configuration file was created.

The process of rendering the widget 214 on the web browser of a client computing device that is accessing the website 204 with the widget will now be described. The computing device assembles the rendering of the webpage in a standard way. During the rendering process, the widget 214 looks for the latest configuration file. Upon finding a configuration file, the widget reads the configuration defined in the configuration file, self-configures the necessary HyperText Markup Language (HTML) and JavaScript code to render the intended functionality, and asynchronously post to the marketing support provider 106 that the widget was rendered and give some client information. The widget is rendered with the appropriate functionality and the user can now interact with any user interfaces provided by the widget.

In an embodiment, these widgets according to embodiments of the invention can be used encourage a user to interact socially on a website by offering user incentives. These widget-powered social interactions can be completely configurable and can embrace mechanisms such as email, Facebook action publish, share, twitter post, etc. A user can gain points, levels, or immediate rewards based on their social interactions with the widget-powered social interaction points on a website. The rewards are configurable so the business owner can determine both the qualifying social actions and the types of rewards offered to the customer.

Possible social interactions include email to friends, post to Twitter or other social networking sites, interact with a social button which may publish an action to Facebook or other social networking sites, and share/send the webpage through Facebook or other social networking sites. Possible rewards include coupons, gift cards, exclusive sales and curative sales (which may be determined by the user's social interaction), sweepstake entries, additional sweepstake entries, exclusive content and charitable group goal progress.

As an example, a widget according to embodiments of the invention may provide a button to join a social rewards club using an incentive, such as an exclusive sale. When the user joins the social rewards club, the user can be directed to interact with the site socially to gain access to the exclusive sale. The widget may provide graphics, such as a progress bar, so that the user can see the user's progress towards the exclusive sale. When the user meets the user's social goal, the exclusive sale such as an exclusive flash sale is unlocked and a button is revealed so that the user can access the exclusive sale.

As another example, the user may be prompted to enter a sweepstake for a chance to win a prize, such as a tablet computer. In an embodiment, the widget may provide a registration form for the sweepstake that has been prefilled using the profile of the user from a social networking website such as Facebook to make entering the sweepstake easier for the user.

In an embodiment, the widgets may use conversational social mechanics to encourage users to interact socially with a website. Instead of traditional “like” buttons, the widgets may be used to offer a catalog of actions that can be used with Facebook's action/object open graph mechanisms. User interactions may be published to Facebook (depending on configuration, and user acceptance). Social actions through email, twitter, and Facebook can be used to start a social conversation amongst friends that expands the reach of a campaign. Examples of published Facebook actions include:
Jim recommends Weber grills
Dave wants Madden 13
Jill owns the Galaxy S3
Brian thinks his dog would “woof” the doggie floating Frisbee
Janet would rather be skiing in her Marmot ski jacket

Social rewards provided by the widgets may keep the end users in control of their social interactions. Using the widgets, the users may be provided with information about what actions are publishable and give them easy controls to turn on/off publishing events. In addition, the users may be provided fine-grained controls over what is being shared.

Discovery is an important part of the social viral rewards loop. Through email, twitter, and/or Facebook published actions, social relationships can be exposed to products, deals, sales, and rewards programs. Customers who discover these programs may join the social rewards program supported by the widgets and contribute to the social viral loop.

The widgets that provide social rewards can be configured to allow the users to publish events related to their interactions with the social rewards to the Facebook platform or another social networking website platform. The social rewards program provided by the widgets can offer retailers a low-IT integration path for taking advantage of this social sharing channel. The widgets that provide social rewards that are configured to interact with Facebook utilize an application to handle all publishing events. Retailers do not have to deploy their own new applications, but instead, rely on the service provided by the marketing support provider 106 to handle the publishing actions.

The widgets that provide social rewards contain code to deploy any social rewards programs. All of the code that is deployed runs independently on client machines. Due to the nature of deployment, the marketing support provider 106 cannot directly control access to the social rewards APIs for things like publishing. In order to ensure that the client code is not misused and client users couldn't spoof the intended functionality of the widgets, a multi-tiered strategy can be deployed for ensuring that only valid social rewards actions can be executed.

In an embodiment, the widgets that provide social rewards are client-side JavaScript widgets operating within either a div or iframe on a retailer or business site. The interactions using these widgets are secured using a layered approach. This approach may use client-side certificates (optional). In particular, a client can choose to install a certificate that enables additional referral domain verification for all published social actions. The approach may also use unique retailer or business tokens. In particular, each retailer or business widget is given a unique client identification token which is used in conjunction with certificates, referral uniform resource locator (URLs), and meta-data verification to ensure that only approved sources are able to publish actions. The approach may also use product meta data verification. In particular, a product meta data verification mechanism may be provided, which can actively evaluate an endpoint-URL from a publish action to verify the correct domain and the correct product. This mechanism can also overwrite API-arguments with the results of the approved domain page. The approach may also use referral URL verification. In particular, referral URLs may be verified for every publishing event to ensure that the referral URL matches the expected domain and retailer token. The approach may use velocity checking. In particular, publishing access can be tracked and dynamically restricted to domains, users, Internet Protocol (IP) addresses, and cookie owners who may be abusing the system. IP/cookie/user combinations that exceed velocity thresholds and are therefore fraud candidates can be blacklisted. The approach may also use black/white lists. Any IP/cookie/user/merchant/security token that looks like it is involved in activity that is not authorized by the retailer can be blacklisted. Any IP/cookie/user/merchant/security token can be whitelisted to ensure that retailers or other businesses and the marketing support provider 106 can undergo significant testing (including load testing) without being banned by the fraud engine. The approach may also use action white-lists. In particular, each domain/retailer can have a small set of approved actions that may be published. Actions outside of that whitelist will be both ignored and security alerts may be generated.

In an embodiment, the social rewards provided by the widgets can be integrated with external loyalty programs. The widget-based social rewards is designed to be able to transmit and receive information to and from external loyalty programs using web services and batch file reconciliation. The widget-based social rewards can offer various APIs that can be polled by external social rewards programs in order to import user data, user actions and social reward status. The widget-based social rewards is able to integrate with external APIs in order to interact directly with external programs. As an example, the widget-based social rewards may be able to publish offers, discounts, and rewards to external loyalty systems based on user's social rewards interactions. The widget-based social rewards can interact directly with external loyalty APIs to dynamically attribute social rewards actions to a specific loyalty user. The widget-based social rewards can export batch reports concerning social interactions that can be imported into external loyalty programs. An example of this interaction is that a loyalty provider may want to attribute loyalty points to a user based on social interactions. The widget-based social rewards can provide a document that lists all users who have qualified for the additional loyalty points. This document can be imported into the external loyalty system. The widget-based social rewards may provide all of the analytics data recorded by the widget-based social rewards and external social networking websites, such as Facebook, through an analytics dashboard, which can be accessed by the operators of the business websites. All recorded data can be exported for external consumption. All data is also available via real time web services for easy external access.

The dashboard provided by the marketing support provider 106 in accordance with an embodiment of the invention may give operators of the business websites a snapshot view of the state of their active, past and draft promotions. The dashboard can be configured to display a subset of available features depending on user permissions.

The dashboard may display a promotion list that shows a dashboard view of all promotions: Active, Completed, All. Previews for all output channels (e.g., Facebook, Twitter, email, microsite, mobile, widget, and adwords) are available from this view. Edit processes can be initialed from the promotion list screens. Individual promotion analytics can be launched from the promotion summary lists. The dashboard may display links sections that gives the user quicklinks to important features such as creating a promotion, manage catalog, view reports, settings, help, and guided tour. The dashboard may also display promotion performance feature that offers a simple graph output summarizing the current state of “live” promotions. This window gives the user information about real-time data. The data within this simple graph can be turned off and on to simplify the data view. The dashboard may also display performance summary feature that gives a data-centric tabular output of statistics related to all promotions that are currently live or have recently expired. This quick view allows a business manager to quickly and easily access numeric performance statistics. The dashboard may also display recent activity feature that shows an events-based history of the state of the system. This feed shows details about recent system functions such as creating a promotion, promotion expiration, etc. Recent activity feature also shows event-based history regarding interaction with live promotions. Activity entries that may appear include: “fans” milestones, page view milestones, sales milestones and system load information.

In an embodiment, the widgets may be used to overwrite existing functionality of a website. This requires a few lines of JavaScript to be included on a merchant website. The JavaScript for each client site is configured to dynamically replace existing functionality with another functionality, such as site buttons with “social gated” functionality. An example is that an existing “Add to Cart” button can be dynamically replaced by a “Love” button that forces the user to partake in some social action in order to get access to the “Add to Cart” button. This mechanism can be used to add “social gating” to buttons ranging from: “add to cart”, “purchase”, “add deal to loyalty card”, “get a discount”, etc.

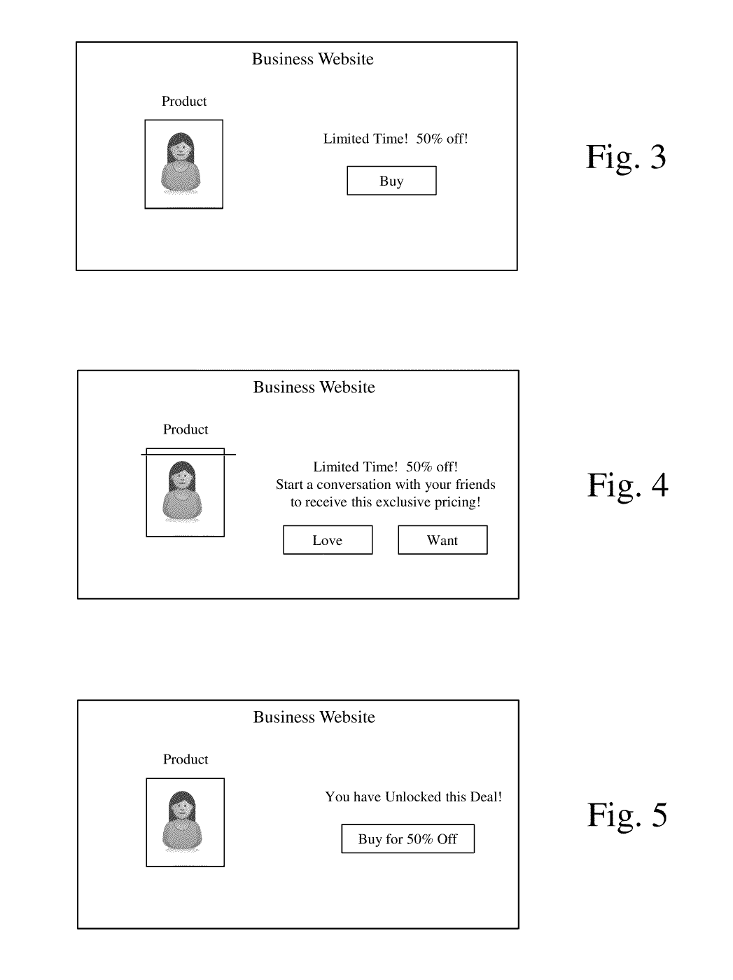

The process of integrating a social rewards “social gate” rewrite button onto a business website using the widgets according to an embodiment of the invention is described with reference to FIGS. 3-5. An operator of a business website, as shown in FIG. 3, integrates a “blank” widget onto the business website (usually onto product pages). The business website in FIG. 3 is a standard business website before widget integration. In particular, the webpage in FIG. 3 shows a special deal for an item with special pricing with a “buy” button. The process of integrating a blank widget onto a business website consists of adding two JavaScript include statements in the header of a webpage as well as a container area (div or iframe) where the desired functionality will be rendered. One of the JavaScript files is a custom file designed for this specific site or webpage. The two JavaScript include statements can have the following format:

<script src=“http://{CDN}/{businessId}/common.js”>

<script src=“http://{CDN}/{businessId}/businessSpecific.js”>

After the widget integration, when the webpage renders, the JavaScript executes and replaces the “buy” button with the configured “social gate” buttons, such as “love” and “want” buttons, as shown in FIG. 4. These social buttons are now rendered in place of the previous “buy” button. When the page renders, a user must click on one of the social buttons to unlock the deal. When the user clicks the social button, the social action is published to a social networking website, such as Facebook, and the user then gains access to the “Buy” button, as shown in FIG. 5, and can proceed through the normal merchant checkout flow.

In an embodiment, the marketing system 100 incorporates an innovative solution to the problem of mobile-capable social networking website (such as Facebook) apps. In the following description, Facebook is used as an exemplary social networking website. However, the solution described herein can be applied to different social networking websites. Typically, Facebook apps do not work on mobile renderings (either mobile browser view, or native mobile applications). The marketing system solves this problem by processing published special Facebook links. These links initially redirect to the servers of the marketing support provider. The marketing support provider servers determine if the user is on a desktop or mobile device. For desktop devices, the marketing support provider redirects directly to the Facebook tab that renders that appropriate application. For mobile devices, the marketing support provider redirects to a marketing support provider-hosted mobile-compliant whitelabel site. On this mobile site, the marketing support provider supports Facebook-connect login to enable Facebook specific features such as “like”, “share”, and “send”. The mobile rendering gives a representation of the promotion (coupon, game, poll, sweepstakes) in a mobile format. The merchant may choose to allow direct access to these promotions in the mobile rendering, or force a Facebook Connect login process. All Facebook-capable promotions are designed to have a mobile rendering.

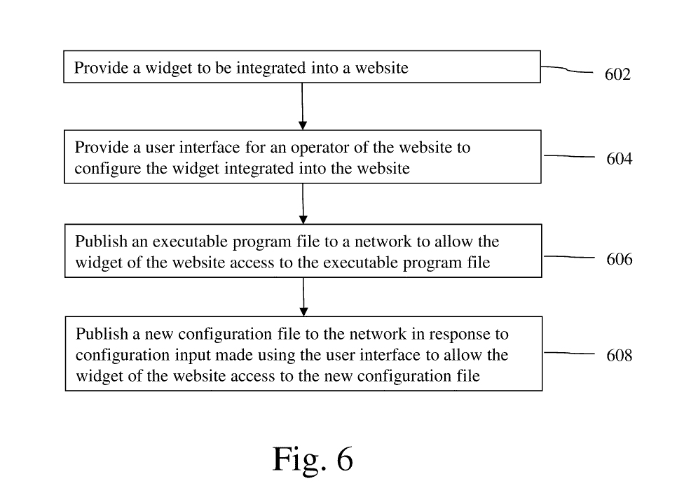

A method for providing functionalities to websites in accordance with an embodiment of the invention is described with reference to a flow diagram of FIG. 6. At block 602, a widget to be integrated into a website is provided. The widget includes a reference to at least one executable program file and a mechanism to look for a configuration file for the widget. At block 604, a user interface is provided for an operator of the website to configure the widget integrated into the website. At block 606, the executable program file is published to the network to allow the widget of the website access to the executable program file. At block 608, a new configuration file is published to a network in response to configuration input made using the user interface to allow the widget of the website access to the new configuration file. The widget of the website is configured to retrieve the executable program and the new configuration file to execute the executable program and self-configure using the new configuration file.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for changing functionalities of websites, the method comprising:
providing a widget to be integrated into a website, the widget including a reference to at least one executable program file and a mechanism to look for a configuration file for the widget;
providing a user interface for an operator of the website to configure the widget integrated into the website;
publishing the executable program file to a network to allow the widget of the website access to the executable program file; and
publishing a new configuration file to the network in response to configuration input made using the user interface to allow the widget of the website access to the new configuration file,
wherein the widget of the website is configured to retrieve the executable program and the new configuration file to execute the executable program and self-configure using the new configuration file.

2. The method of claim 1 wherein the widget includes a reference to at least one JavaScript file.

3. The method of claim 1 wherein the widget is configured to constantly look for the configuration file that defines the widget using code included in the JavaScript file.

4. The method of claim 3 wherein the widget is configured to use the latest configuration file to define its functionality when there are more than one version of the configuration file for the widget.

5. The method of claim 1 wherein the configuration file includes a business identification, a widget identification, a webpage identifier and the time when the configuration file was created.

6. The method of claim 1 wherein the publishing the executable program file and the configuration file includes publishing the executable program file and the configuration file to a content delivery network.

7. The method of claim 1 wherein the providing the user interface includes providing a web interface for the operator of the website to configure the widget integrated into the website.

8. A system comprising:
a widget to be integrated into a website, the widget including a reference to at least one executable program file and a mechanism to look for a configuration file for the widget; and
a marketing support provider that has access to a network and websites, including the website with the widget, the marketing support provider including one or more servers that are configured to provide a user interface for an operator of the website to configure the widget integrated into the website, to publish the executable program file to the network to allow the widget of the website access to the executable program file, and to publish a new configuration file to a network in response to configuration input made using the user interface to allow the widget of the website access to the new configuration file,
wherein the widget of the website is configured to retrieve the executable program and the new configuration file to execute the executable program and self-configure using the new configuration file.

9. The system of claim 8 wherein the widget includes a reference to at least one JavaScript file.

10. The system of claim 8 wherein the widget is configured to constantly look for the configuration file that defines the widget using code included in the JavaScript file.

11. The system of claim 10 wherein the widget is configured to use the latest configuration file to define its functionality when there are more than one version of the configuration file for the widget.

12. The system of claim 8 wherein the configuration file includes a business identification, a widget identification, a webpage identifier and the time when the configuration file was created.

13. The system of claim 8 wherein the network includes a content delivery network.

14. The system of claim 8 wherein the user interface includes a web interface for the operator of the website to configure the widget integrated into the website.

15. A computer-readable storage medium containing program instructions for providing functionalities to websites, wherein execution of the program instructions by one or more processors of a computer system causes the one or more processors to perform steps comprising:
providing a widget to be integrated into a website, the widget including a reference to at least one executable program file and a mechanism to look for a configuration file for the widget;
providing a user interface for an operator of the website to configure the widget integrated into the website;
publishing the executable program file to the network to allow the widget of the website access to the executable program file; and
publishing a new configuration file to a network in response to configuration input made using the user interface to allow the widget of the website access to the new configuration file,
wherein the widget of the website is configured to retrieve the executable program and the new configuration file to execute the executable program and self-configure using the new configuration file.

16. The computer-readable storage medium of claim 15 wherein the widget includes a reference to at least one JavaScript file.

17. The computer-readable storage medium of claim 15 wherein the widget is configured to constantly look for the configuration file that defines the widget using code included in the JavaScript file.

18. The computer-readable storage medium of claim 18 wherein the widget is configured to use the latest configuration file to define its functionality when there are more than one version of the configuration file for the widget.

19. The computer-readable storage medium of claim 15 wherein the configuration file includes a business identification, a widget identification, a webpage identifier and the time when the configuration file was created.

20. The computer-readable storage medium of claim 15 wherein the publishing the executable program file and the configuration file includes publishing the executable program file and the configuration file to a content delivery network.
